(19) United States
(12) Patent Application Publication
(10) Pub. No.: US 2026/0286949 A1
(43) Pub. Date: Sep. 24, 2026

(54) LIQUID ACTUATED PUMP, PUMP UNIT, AND METHOD OF PUMPING A PROCESS FLUID

(71) Applicant: CYTIVA SWEDEN AB, Uppsala (SE)

(72) Inventors: Andreas Lundin, Uppsala (SE); Klaus Gebauer, Uppsala (SE); Mats Lundkvist, Uppsala (SE); Per Normann, Uppsala (SE)

(21) Appl. No.: 19/474,753

(22) PCT Filed: Apr. 9, 2024
(86) PCT No.: PCT/EP2024/059622

§ 371 Date: Oct. 13, 2025

(30) Foreign Application Priority Data
Apr. 12, 2023 (GB) 2305344.0

(51) Int. Cl. F04B 43/073; F04B 43/00

(52) U.S. Cl. CPC F04B 43/0733; F04B 43/0054; F04B 43/0081

(57) ABSTRACT

Liquid actuated pump 100, 200, 300, 400 for a bioprocessing system, the pump 100, 200, 300, 400 comprising: a pump chamber 130, 230, 330; a flexible diaphragm 132 configured to form a barrier between a control liquid portion 136 of the pump chamber 130, 230, 330 and a process fluid portion 134 of the pump chamber 130, 230, 330; a process fluid flow path 110, 210, 310 comprising the process fluid portion 134 of the pump chamber 130, 230, 330; and a control liquid flow path 120, 220 comprising: an inlet 122 to the pump 100, 200, 300, 400; an outlet 124 from the pump 100, 200, 300, 400; and the control liquid portion 136 of the pump chamber 130, 230, 330; wherein the control liquid flow path 120, 220 is configured to accommodate at least part of a trapped volume of control liquid, and wherein displacement of the trapped volume of control liquid causes deformation of the flexible diaphragm 132, the deformation of the flexible diaphragm 132 causing movement of a process fluid in the process fluid flow path 110, 210, 310.

### FIELD

The present disclosure relates to a liquid actuated pump for a bioprocessing system, a pump unit for the bioprocessing system, methods of operating the liquid actuated pump.

### BACKGROUND

Bioprocessing systems typically require effective liquid handling in order to carry out processes under controlled and contained conditions. This may involve aseptic handling in closed liquid handling systems and the use of pre-sterilised components.

Recently, modular bioprocessing systems based on single-use flow paths have been developed. The single-use components are implemented as modular or integrated consumables that are intended to be disposed of after a process run. Single-use flow path components eliminate the time-and labour-consuming pre-and post-cleaning of the wetted flow path. This increases the overall process efficiency and reduces cost. The elimination of equipment cleaning and any associated cleaning validation processes also greatly reduces the risk of cross-contamination between different batches being processed using the bioprocessing system.

Single-use components are, by their nature, disposed of after use. Therefore, it is beneficial to minimise the cost, complexity and material usage of such single-use components, while maximising the ease of production. Moreover, it is beneficial to provide single-use components that are configurable for a range of liquid handling processes, in order to minimise the number of types of single-use component that are needed for a particular liquid handling operation. Further, it is beneficial to provide single-use components that are flexible and scalable to adapt to different processing capacity or processing needs. Pumps or valves, for example, may need to be provided in different sizes to handle a range of liquids to be processed in different volumes and/or with different flow rates.

An example of a single-use component that includes pneumatically or hydraulically actuated diaphragm valves is described in U.S. Pat. No. 10,451,591. This document describes a valve system in which a pneumatic or hydraulic control system controls the application of pneumatic or hydraulic pressure to actuate diaphragm valves in a valve block forming part of a single-use flow path. The diaphragm valves are used to control the flow of liquid in the single-use flow path. Prior to actuation of the diaphragm valves, the valve block is coupled to a connector unit that allows for connection and disconnection of conduits in the pneumatic or hydraulic control system with conduits of the valve block.

Bioprocessing comprises a range of different liquid handling operations. Requirements on the liquid handling equipment, for example pumps and valves, may be different depending on the type of processing operation, usually called Unit Operation (UOp). A range of crucial separation and purification Unit Operations, for example tangential flow filtration (TFF) and chromatography, require pumps delivering a continuous and pulsation-free liquid to achieve the efficiency and reproducibility required in biopharmaceutical processing.

In TFF, continuous and substantially pulsation-free liquid flow enables stable conditions at the filtration device in terms of flow and pressure to achieve high efficiency and performance of the separation and to avoid fouling of the filter device. In chromatography, continuous and accurate liquid flow is a pre-requisite for good control and reproducibility of the operation, allowing for accurate separation of different effluent fractions to collect the drug substance of interest with desired purity and yield. There are other Unit Operations in bioprocessing where continuous and stable, pulsation-free flow is needed or advantageous, for example in single pass TFF operations, normal flow filtration, plug flow reactions, mixing operations, etc.

Current pump technologies for bioprocessing systems are typically based on pump design solutions that directly engage liquid displacement parts inside the pump, such as pistons, diaphragms, lobe rotors, centrifugal rotors or a peristaltic tube by the use of motors or electrical drives attached to the pump. Especially for single-use technology, the need for directly pairing and connecting a re-usable drive unit with a single-use disposable pump unit gives significant limitations in regard to several aspects, for example an efficient utilization of space, flexibility in arranging, integrating and miniaturizing liquid handling components, as well as usability in installing, removing and replacing single-use processing liquid handling units as consumable devices.

Especially when reducing scale and working volumes for single-use bioprocessing, as is needed for production of drug substances for individualized therapies, for example, current technology is not suited to facilitate the physical miniaturization needed to provide single-use consumables of small physical size and low liquid hold-up volume, which is required for achieving high separation efficiency as well as enabling cost efficient solutions that are easy and safe to use.

Therefore, there is a need for providing single-use systems and components that achieve high efficiency, accuracy and scalability for processing of small volumes. In particular, there is a need for providing pump solutions which provide continuous and substantially pulsation-free flow for small scale single-use separations that minimise cost and complexity of such single-use components.

### SUMMARY

This summary introduces concepts that are described in more detail in the detailed description. It should not be used to identify essential features of the claimed subject matter, nor to limit the scope of the claimed subject matter.

According to a first aspect of the present disclosure, there is provided a liquid actuated pump for a bioprocessing system, the pump comprising: a pump chamber; a flexible diaphragm configured to form a barrier between a control liquid portion of the pump chamber and a process fluid portion of the pump chamber; a process fluid flow path comprising the process fluid portion of the pump chamber; and a control liquid flow path comprising: an inlet to the pump; an outlet from the pump; and the control liquid portion of the pump chamber; wherein the control liquid flow path is configured to accommodate at least part of a trapped volume of control liquid, and wherein displacement of the trapped volume of control liquid causes deformation of the flexible diaphragm, the deformation of the flexible diaphragm causing movement of a process fluid (e.g. a process liquid) in the process fluid flow path.

The liquid actuated pump of the first aspect therefore allows a process liquid to be driven using a liquid actuated pump with a low number of components. The low number of components of the liquid actuated pump allows the liquid actuated pump to be provided as a low-cost consumable (such as a single use consumable), to be small in size, to be manufactured using a low amount of material (for reduced environmental impact), and to be simple to use. Further, the utilization of a flexible diaphragm for the pump action ensures full closure and integrity of the process flow path such that there is no risk of contamination of the process fluid or leakage from the process side to the environment and/or control liquid. When the process fluid is a process liquid, and therefore considered to be incompressible, the amount of the trapped volume control liquid displaced into the pump chamber is equal to the amount of process liquid displaced from the pump chamber. Accordingly, there is a one-to-one relationship between the displacement of the trapped volume of control liquid and the displacement of the process liquid in the liquid actuated pump. This allows for high accuracy of the pump, because precise volumes of process liquid can be displaced from the liquid actuated pump according to the invention. The liquid actuated pump of the first aspect is also suitable for incorporation into a pumping system having two pumps and two parallel-connected pump chambers, alternatively more than two pumps and two parallelly connected pump chambers, in which one pump supplies a positive pressure to displace process fluid from one pump chamber while another pump supplies a negative pressure to draw process fluid into another pump chamber (with the operation of the pumps then being reversed). Such an arrangement permits substantially continuous and pulsation-free flow of process fluid.

According to a second aspect of the present disclosure, there is provided a pump unit for a bioprocessing system, the pump unit comprising: a pump unit outlet configured for connection to a control liquid inlet of a liquid actuated pump; a pump unit inlet configured for connection to a control liquid outlet of the liquid actuated pump, such that a control liquid flow path includes the pump unit outlet, the liquid actuated pump, and the pump unit inlet; a pump configured to drive movement of a control liquid in the control liquid flow path; and one or more valves configured to cause a volume of control liquid to be trapped in a portion of the control liquid flow path comprising the pump and the liquid actuated pump, such that movement of the pump causes displacement of the trapped volume of liquid.

According to a third aspect of the present disclosure, there is provided a method of pumping a process fluid in a bioprocessing system, the method comprising: providing a liquid actuated pump and a pump unit, wherein the liquid actuated pump comprises: a pump chamber; and a flexible diaphragm configured to form a barrier between a control liquid portion of the pump chamber and a process fluid portion of the pump chamber; trapping a volume of control liquid in a portion of a control liquid flow path, wherein the portion of the control liquid flow path comprises a pump of the pump unit and the control liquid portion of the pump chamber; and displacing the trapped volume of control liquid using the pump to deform the flexible diaphragm and cause movement of a process fluid in a process fluid flow path comprising the process fluid portion of the pump chamber.

### BRIEF DESCRIPTION OF FIGURES

Specific embodiments are described below by way of example only and with reference to the accompanying drawings, in which:

FIG. 1 shows a schematic diagram of a first pumping system comprising a liquid actuated pump and a pump unit according to a first example.

FIG. 2 shows a section view through the liquid actuated pump according to the first example.

FIG. 3 shows a schematic diagram of a second pumping system comprising a liquid actuated pump according to a second example.

FIG. 4 shows a schematic diagram of a third pumping system comprising a liquid actuated pump according to a third example.

FIG. 5 shows a schematic diagram of a pumping system according to a fourth example.

FIGS. 6A and 6B show valve states of the pumping system shown in FIG. 5 during priming of the pumping system.

FIG. 7 shows valve states of the pumping system shown in FIG. 5 when used to drive a liquid actuated pump.

FIG. 8 shows valves states of the pumping system shown in FIG. 5 during draining of the pumping system.

FIG. 9 is a flowchart of a method of performing a pumping operation to pump a process fluid using a pumping system.

FIG. 10 is a flowchart of a method of priming a pumping system.

FIG. 11 is a flowchart of a method of operating a pumping system to pump a process fluid.

FIG. 12 is a flowchart of a method of draining a pumping system.

### DETAILED DESCRIPTION

Implementations of the present disclosure are explained below with particular reference to bioprocessing systems. It will be appreciated, however, that the implementations described herein are also applicable to other liquid handling operations in which a fluid is to be pumped.

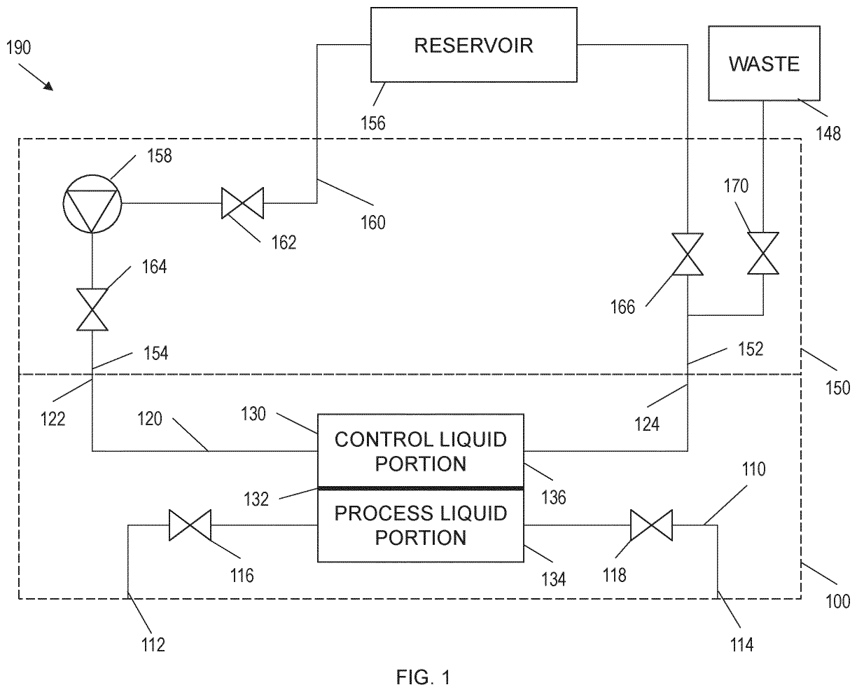

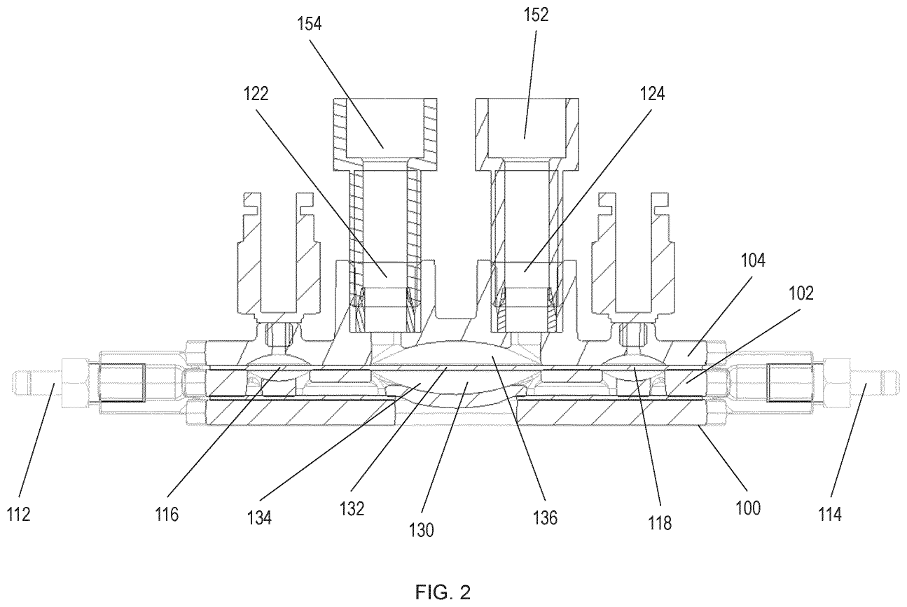

FIG. 1 is a schematic diagram of a pumping system 190 comprising liquid actuated pump 100 coupled to a pump unit 150, while FIG. 2 is a section view through the liquid actuated pump 100. The liquid actuated pump 100 may be a component of a bioprocessing system, such as a tangential flow filtration (TFF) system or a chromatography system.

As shown in FIG. 1, the liquid actuated pump 100 includes two flow paths: a process fluid flow path 110, and a control liquid flow path 120. The process fluid flow path 110 may provide a fluidic connection to columns, filters, reservoirs, conduits and/or chambers (not shown) for handling a liquid being processed by a bioprocessing system (which may be or include, for example, a drug formulation, monoclonal antibody (MAB), mRNA, etc.). As shown in FIG. 1, the process fluid flow path 110 includes a process fluid inlet 112, a process fluid outlet 114, a first valve 116 disposed between the process fluid inlet 112 and a pump chamber 130 of the liquid actuated pump 100, and a second valve 118 disposed between the pump chamber 130 and the process fluid outlet 114.

Where the liquid actuated pump 100 is a component of a TFF system, the process fluid inlet 112 may receive process fluid (e.g. liquid) from a TFF reservoir and/or a diafiltration buffer reservoir, while the process fluid outlet 114 may provide liquid to a TFF filter. Where the liquid actuated pump 100 is a component of a chromatography system, the process fluid inlet 112 may receive process fluid (e.g. liquid) from an inlet container (which may receive one or more liquids from an inlet manifold and associated valves), and the process fluid outlet 114 may provide liquid to a chromatography column. The process fluid inlet 112 and process fluid outlet 114 can also be seen in FIG. 2.

In one example, each of the first valve 116 and the second valve 118 is a check valve (such as a ball valve, membrane valve, or umbrella valve). Implementing the first valve 116 and the second valve 118 as check valves allows passive valves to be implemented, thereby removing the need for active valves and further simplifying the operation of the liquid actuated pump 100. Alternatively, as shown in FIG. 2, each of the first valve 116 and the second valve 118 may be an active valve such as a fluid-actuatable (e.g. air-actuatable) membrane valve. Active valves such as fluid-actuatable membrane valves can be incorporated using fewer components (thereby reducing complexity of the liquid actuated pump 100), particularly if a flexible layer forming a diaphragm of the pump chamber 130 (described further below) is also utilised to provide the membranes of the fluid-actuatable membrane valves (as shown in FIG. 2).

The control liquid flow path 120 includes conduits for applying pressure to a diaphragm 132 of the pump chamber 130 using a control liquid. As shown in FIG. 1, the control liquid flow path 120 includes a control liquid inlet 122 disposed upstream of the pump chamber 130, and a control liquid outlet 124 disposed downstream of the pump chamber 130.

The diaphragm 132 of the pump chamber 130 divides the pump chamber 130 into two portions: a process fluid portion 134 of the pump chamber 130, and a control liquid portion 136 of the pump chamber 130. The process fluid flow path 110 includes the process fluid portion 134 of the pump chamber 130, while the control liquid flow path 120 includes the control liquid portion 136 of the pump chamber 130. The diaphragm 132 forms an impermeable barrier between the process fluid portion 134 and the control liquid portion 136, such that there is no leakage of fluid between the two portions 134, 136. The impermeability of the diaphragm 132 to liquid allows the diaphragm 132 to be displaced by application of pressure to the diaphragm 132 using a control liquid.

As shown in more detail in FIG. 2, the diaphragm 132 may be sandwiched between two parts of the liquid actuated pump 100. A single unitary diaphragm 132 (e.g. provided as a sheet of thermoplastic elastomer (TPE)) may be used to provide pumping action in multiple cavities, for example in a control liquid portion of a pump chamber, a pump chamber and/or a process fluid portion of a pump chamber. Such a single unitary diaphragm 132 may also form a structural joining part of a sandwiched structure in which a liquid actuated pump is housed (e.g. in a unitary single use cassette designed for small volume sample bioprocessing applications). A first part 102 may include the process fluid flow path 110, while a second part 104 may include the control liquid flow path 120. The diaphragm 132 may, for example, be formed of a flexible material (e.g. a polymer) that is sufficiently pliant to permit deflection when a pressure is applied using a control liquid. Such pliant pressure-responsive material may, for example, be a fluoropolymer or an elastomer. As one specific example, the diaphragm 132 is formed of perfluoroalkoxy copolymer resin thermoplastic material. Materials such as silicone rubber, EPDM rubber and thermoplastic elastomers (TPE) may alternatively be used. A TPE is particularly suitable for bonding to the first part 102 and/or the second part 104 of the liquid actuated pump 100, while providing high flexibility (e.g. 700% elongation prior to breakage). One example of a particularly suitable TPE for the diaphragm 132 is Mediprene® TPE from Hexpol AB of Malmö, Sweden.

Suitable materials for the first part 102 and second part 104 include, for example, polypropylene, polymethylpentene (also known as TPX®), and cyclic olefin copolymer (COC). One example of a particularly suitable material for the first part 102 and the second part 104 is COC with a low glass transition temperature (e.g. Tg between 60° C. and 100° C., and preferably between 70° C. to 85° C.) to accommodate bonding to a TPE such as Mediprene®. It will be appreciated that other glass transition temperature ranges will be applicable for alternative polymers, in order to accommodate bonding to the diaphragm 132. However, in examples in which the diaphragm 132 is clamped or screwed to the first part 102 and/or second part 104 (instead of being bonded), materials such as stainless steel may be used for the first part 102 and/or second part 104, along with an elastomeric diaphragm material such as Kalrez® elastomers from DuPont of Wilmington, Delaware, US.

In various preferred embodiments, diaphragm 132 comprises TPE (with at least one thermoplastic and at least one elastomeric component) and is bonded to a first part 102 and/or a second part 104 that comprise(s) cyclic olefin copolymer (COC). Bonding between such components may be provided by temperature induced heat/diffusion bonding, for example.

The elastomeric component may comprise a SEBS (Styrene-Ethylene-Butadiene-Styrene) matrix, which can provide several glass transition temperatures to provide the elastomeric component with different properties. For example, there may also be included therein soft segments such as polyethylene and polybutadiene, and stiff segments such as polystyrene.

The TPE based diaphragm 132 also comprises at least one material component that has a glass transition temperature (Tg) that is matched to the glass transition temperature (Tg) of the COC. This material component may be a thermoplastic used, for example, to replace the polypropylene that is otherwise used in a conventional TPE based membrane.

For example, COC8007 may be used with Tg=65-95° C. One or more thermoplastic component (with a lower Tg or melting temperature than polypropylene) added into the TPE based membrane may then be used to provide a Tg that is substantially matched thereto.

Matching of the Tg properties in this way enables improved diffusion bonding to occur by way of molecular movement between the components and provides a strong bond therebetween. The TPE based diaphragm 132 may thus be used to provide extra structural support to affix the first part 102 and the second part 104 together or might, alternatively, be used solely to provide such support therebetween.

Generally, the materials used for construction of single-use bioprocessing components should be compatible with typical sterilisation methods, such as gamma or X-ray irradiation and/or ethylene oxide sterilisation. Further, materials used for components that are in contact with process fluids (so-called “wetted parts”) should be in compliance with material requirements satisfying the demands of regulatory authorities and current best practice and standards in cGMP processing, such as, for example, being of animal-free origin, being in compliance with USP (class 6) requirements, and so on.

Returning to FIG. 1, it can be seen that the pump unit 150 includes a pump unit inlet 152 and a pump unit outlet 154 (which are also shown schematically in FIG. 2). The pump unit outlet 154 is in fluidic communication with the control liquid inlet 122 of the liquid actuated pump 100, such that the control liquid inlet 122 receives control liquid from the pump unit outlet 154. Likewise, the pump unit inlet 152 is in fluidic communication with the control liquid outlet 124 of the liquid actuated pump, such that the pump unit inlet 152 receives control liquid from the control liquid outlet 124. The fluidic communication between the pump unit inlet 152 and the control liquid outlet 124 and between the pump unit outlet 154 and the control liquid inlet 122 may be a direct connection between the respective outlets and inlets. Alternatively, the respective outlets and inlets may be connected via additional conduits (e.g. flexible tubing).

The pump unit 150 is also in fluidic communication with a reservoir 156, which stores the control liquid that is provided to the control liquid flow path 120 of the liquid actuated pump 100. The reservoir 156 may be provided in the form of a falcon tube or plastic bag containing the control liquid. In some examples, the reservoir 156 may be a component of the pump unit 150 itself. The control liquid may be, for example, water, oil, glycerine, or a blend of water and alcohol (e.g. ethanol), such as a blend with 20% alcohol. The control liquid is used to deform the diaphragm 132 of the pump chamber 130 and is preferably, therefore, a low viscosity liquid. Using a blend of water and alcohol prevents microbial development within the pump unit 150. The control liquid may also include other additives to prevent microbial growth. In one example, the control liquid is the same as a liquid (e.g. a water-alcohol blend) used by the pump unit 150 for rinsing bioprocessing equipment (e.g. for rinsing ‘behind’ the pistons of a piston pump). In this case, the same reservoir can be used for rinsing and pumping operations. Other control liquids and compositions may be utilized. Further, control liquids may be pre-conditioned, such as pre-filtered, pre-sterilized, pre-degassed or otherwise pre-treated. Alternatively, control liquids may be treated during use, for example by filters, bioburden control regimes, such as UV light treatment etc. The pumping system 190 and/or the bioprocessing system may be configured to automatically manage filling, treatment and/or removal and disposal of the control liquid; it may also be configured to perform cleaning of pump unit 150 and/or its hydraulic liquid circuitry before or after processing.

The pump unit 150 further comprises a pump 158 (such as a piston pump), which drives movement of the control liquid in a control liquid flow path 160 of the pumping system 190. The control liquid flow path 160 of the pumping system 190 includes the reservoir 156, the pump 158, the pump unit outlet 154, the control liquid flow path 120 of the liquid actuated pump 100, and the pump unit inlet 152. FIG. 1 shows an example in which the control liquid received via the pump unit inlet 152 can be returned to the reservoir 156 via valve 166 (described further below), for example during priming of the pumping system 190. In other words, the control liquid flow path 160 is configured to return the control liquid to the reservoir 156. In addition, as shown in FIG. 1, control liquid received via the pump unit inlet 152 can be routed to a waste outlet 148 via waste outlet valve 170 (also described further below), for example during draining of the pumping system 190.

The pump unit 150 also includes a plurality of valves. A first valve 162 is disposed upstream of both the pump 158 and the liquid actuated pump 100 in the control liquid flow path 160. A second valve 164 is disposed between the pump 158 and the liquid actuated pump 100 in the control liquid flow path 160. A third valve 166 is disposed downstream of both the pump 158 and the liquid actuated pump 100 in the control liquid flow path 160. In the example shown in FIG. 1, the first valve 162 and the second valve 164 are disposed upstream of the pump unit outlet 154 in the control liquid flow path 160, while the third valve 166 is disposed downstream of the pump unit inlet 152 in the control liquid flow path 160.

In the example shown in FIG. 1, the first valve 162 and the second valve 164 allow the pump 158 to be operated to drive movement of the control liquid through the control liquid flow path 160. Specifically, when the pump 158 is drawing control liquid from the reservoir 156 (i.e. by providing a negative pressure), the second valve 164 is closed and the first valve 162 is open. Closure of the second valve 164 prevents the pump 158 from drawing control liquid from components downstream of the pump 158 (e.g. from the control liquid flow path 120 of the liquid actuated pump 100). Then, when the pump 158 is used to drive forward movement of the control liquid along the control liquid flow path 160, the first valve 162 is closed and the second valve 164 is open. Closure of the first valve 162 prevents the pump 158 from driving the control liquid back to the reservoir 156.

Together with the first valve 162, the third valve 166 allows a volume of control liquid to be trapped in a portion of the control liquid flow path 160 that comprises the pump 158 and the liquid actuated pump 100. Specifically, once the portion of the control liquid flow path 160 between the first valve 162 and the third valve 166 is filled with control liquid (and is preferably free from gas bubbles), the first valve 162 and the third valve 166 can be closed in order to trap a volume of control liquid in that portion of the control liquid flow path 160.

In one example, each of the first valve 162, the second valve 164 and the third valve 166 is an active valve such as an active membrane valve. The first valve 162 and the third valve 166 are implemented as active valves because these valves need to be completely closed when the pump unit 150 is used to drive movement of the process fluid in the liquid actuated pump 100. The second valve 164 is implemented as an active valve because this valve needs to be completely open when the pump unit 150 is used to drive movement of the process fluid in the liquid actuated pump 100. In one example, the third valve 166 is a pressure control valve that permits discharge of liquid to the reservoir 156 in the event of a build-up of excess pressure in the control liquid flow path 160.

As shown in FIG. 1, the pump unit further comprises a waste outlet valve 170 that permits control liquid to be discharged to a waste outlet 148. The conduit connecting the control liquid flow path 160 to the waste outlet valve 170 may branch from the control liquid flow path 160 at a point between the pump unit inlet 152 and the third valve 166. Accordingly, to return control liquid to the reservoir 156, the third valve 166 is opened while the waste outlet valve 170 is closed. Conversely, when routing control liquid to the waste outlet 148, the third valve 166 is closed and the waste outlet valve 170 is opened. The waste outlet valve 170 may also be a pressure control valve that permits discharge of liquid to the waste outlet 148 in the event of a build-up of excess pressure in the control liquid flow path 160.

In use, the liquid actuated pump 100 is firstly connected to the pump unit 150. In one example, the second valve 164 and the third valve 166 are closed during connection of the liquid actuated pump 100 to the pump unit 150, in order to prevent accidental leakage of control liquid from the pump unit outlet 154 or the pump unit inlet 152.

The pump 158 is then used to drive movement of the control liquid through the control liquid flow path 160 of the pumping system 190 (which includes the control liquid flow path 120 of the liquid actuated pump 100). This is achieved by firstly opening the first valve 162 while keeping the second valve 164 closed and applying a negative pressure using the pump 158 in order to draw control liquid from the reservoir 156 into the pump 158. Then, a positive pressure is applied using the pump 158 with the first valve 162 closed and with the second valve 164 and third valve 166 open, in order to drive movement of the control liquid along the control liquid flow path 160. These steps are then repeated in order to draw an additional volume of control liquid from the reservoir 156 (i.e. with the second valve 164 closed and the first valve 162 open), and to drive movement of the additional volume of control liquid along the control liquid flow path 160 (i.e. with the first valve 162 closed and the second valve 164 open).

Once the portion of the control liquid flow path 160 between the first valve 162 and the third valve 166 and including the pump 158 contains control liquid, the first valve 162 and the third valve 166 can be closed. This results in a volume of the control liquid being trapped between the first valve 162 and the third valve 166. This trapped volume of control liquid is partially accommodated in the control liquid flow path 120 of the liquid actuated pump 100, and partially accommodated in the pump unit 150 (specifically, between the first valve 162 and the pump unit outlet 154, and between the pump unit inlet 152 and the third valve 166).

Following closure of the first valve 162 and the third valve 166 to trap the volume of control liquid, the pump 158 is used to displace the trapped volume of liquid. In the example shown in FIG. 1, the pump 158 supplies a positive pressure (i.e. by positive displacement of a piston) to drive control liquid out of the pump unit outlet 154. This means that the control liquid flow path 120 of the liquid actuated pump 100 is forced to accommodate a greater volume of control liquid than the volume accommodated prior to activation of the pump 158. The control liquid can be considered an incompressible fluid under the operating conditions of the pump unit 150. In view of the incompressibility of the control liquid, the increased volume of control liquid is accommodated in the control liquid flow path 120 by deformation of the diaphragm 132, which increases the volume of the control liquid portion 136 of the pump chamber 130. The deformation of the diaphragm 132 resulting from displacement of the trapped volume of control liquid consequently reduces the volume of the process fluid portion 134 of the pump chamber 130, thereby driving movement of the process fluid in the process fluid flow path 110.

In other words, by trapping a volume of control liquid between the first valve 162 and the third valve 166, control liquid is trapped between the pump 158 and the diaphragm 132. This means that any movement of the pump 158 is transferred to the diaphragm 132. In addition, it is not necessary to control or monitor the position of the diaphragm 132, because the position of the diaphragm 132 can be determined using the pump 158.

As the control liquid can be considered incompressible under the operating pressures of the pump unit 150, the amount of control liquid displaced by the pump 158 is equal to the amount of control liquid that is accommodated in the control liquid portion 136 of the pump chamber 130. Where the process fluid is a process liquid (and is therefore considered to be incompressible), the amount of control liquid displaced by the pump 158 is equal to the amount of process liquid displaced from the process fluid portion 134 of the pump chamber 130. Accordingly, in an ideal scenario in which the first valve 162 and the third valve 166 can be closed instantaneously, there is a one-to-one relationship between the displacement of the control liquid (controlled by the pump unit 150) and the displacement of the process liquid in the liquid actuated pump 100. This allows precise volumes of process liquid to be displaced from the liquid actuated pump 100, under the control of the pump 158 in the pump unit 150. Precision of process liquid displacement can be improved by reducing the actuation time of the first valve 162 and the third valve 166.

As explained above, each of the first valve 116 and the second valve 118 may be a check valve. In other words, each of the first valve 116 and the second valve 118 may permit the flow of process fluid along the process fluid flow path 110 in the direction of the process fluid outlet 114 and prevent the flow of process fluid in the reverse direction along the process fluid flow path 110. Preferably, the check valves are mechanical check valves that permit forward flow of process fluid and prevent backflow of process fluid without requiring actuation using a control system. When the trapped volume of liquid is displaced by application of a positive pressure from the pump 158 of the pump unit 150, the trapped volume of liquid exerts a positive pressure on the diaphragm 132 to deform the diaphragm 132 and reduce the volume of the process fluid portion 134 of the pump chamber 130, thereby forcing process fluid out of the process fluid portion 134. In this case, the second valve 118 permits the process fluid to flow along the process fluid flow path 110 in the direction of the process fluid outlet 114, while the first valve 116 prevents the process fluid from flowing in the reverse direction.

Similarly, when the pump 158 is subsequently retracted such that a negative pressure differential is provided between the pump 158 and the control liquid portion 136 of the pump chamber 130, the trapped volume of liquid is displaced away from the process fluid portion 134 of the pump chamber 130 such that a negative pressure is exerted on the diaphragm 132, thereby increasing the volume of the process fluid portion 134. In this case, the first valve 116 permits process fluid to be drawn into the process fluid portion 134 of the pump chamber 130 through the process fluid inlet 112, while the second valve 118 prevents process fluid from being drawn into the process fluid portion 134 through the process fluid outlet 114. It will be appreciated that the first valve 116 and the second valve 118 may alternatively be implemented as check valves that permit movement of the process fluid in the opposite direction to that described above (i.e. out of the process fluid inlet 112). Moreover, it will further be appreciated that such functionality of the first valve 116 and the second valve 118 may alternatively be provided using active valves that are opened and closed depending on whether a positive or negative pressure is being supplied by the pump 158.

A process liquid can therefore be driven using a liquid actuated pump 100 with a low number of components. Specifically, a process liquid can be driven using a liquid actuated pump 100 comprising: a pump chamber 130 with a diaphragm 132 dividing the pump chamber 130 into a process fluid portion 134 and a control liquid portion 136; a process fluid flow path 110 including a process fluid inlet 112, a process fluid outlet 114, and the process fluid portion 134 of the pump chamber 130; and a control liquid flow path 120 including a control liquid inlet 122, a control liquid outlet 124, and the control liquid portion 136 of the pump chamber 130. The low number of components of the liquid actuated pump 100 allows the liquid actuated pump 100 to be provided as a low-cost consumable (such as a single use consumable), to be small in size, and to be simple to use.

In addition, provided that there are no cracks or openings in the diaphragm 132 of the pump chamber 130, the control liquid cannot leak into the process fluid flow path.

Accordingly, the process fluid can be driven without risk of contamination by the control liquid.

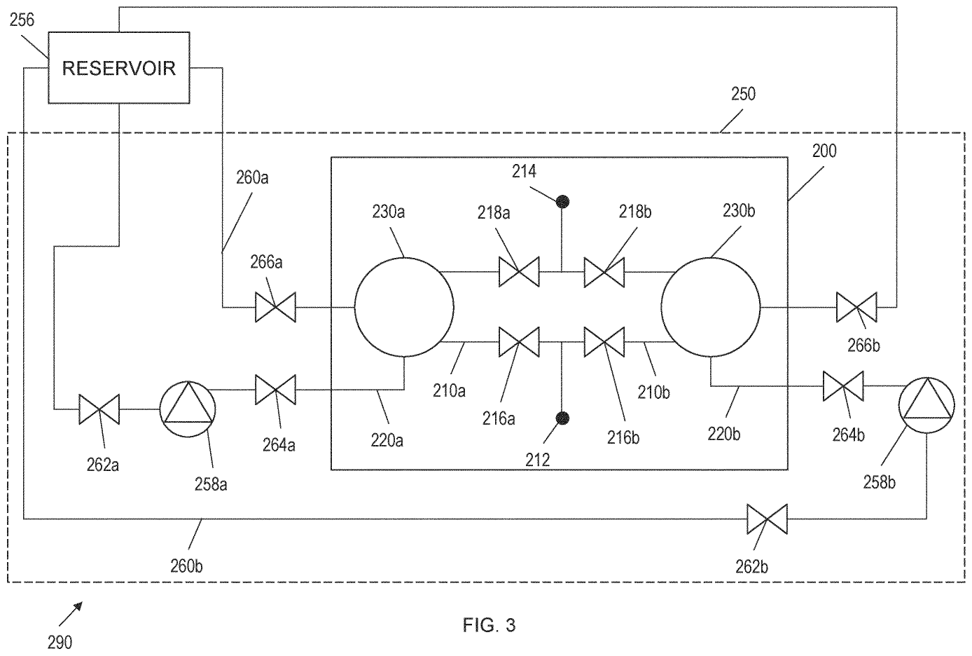

FIG. 3 is a schematic diagram of a second pumping system 290 comprising a second liquid actuated pump 200 and a second pump unit 250. In FIG. 3, the liquid actuated pump 200 and pump unit 250 are shown schematically in plan view.

The liquid actuated pump 200 includes all components of the liquid actuated pump 100 shown in FIGS. 1 and 2. That is, the liquid actuated pump 200 includes: a process fluid flow path 210a including a process fluid inlet 212, a process fluid outlet 214, a first valve 216a and a second valve 218a; a control liquid flow path 220a; and a pump chamber 230a. Likewise, the pump unit 250 includes all components of the liquid actuated pump 150 shown in FIG. 1. That is, the pump unit 250 includes: a connection to a reservoir 256, a pump 258a, a first valve 262a, a second valve 264a and a third valve 266a.

In contrast to the liquid actuated pump 100 shown in FIGS. 1 and 2, the liquid actuated pump 200 shown in FIG. 3 includes a first pump chamber 230a and a second pump chamber 230b, along with a third valve 216b and a fourth valve 218b. The two pump chambers 230 are connected in parallel on the process fluid side of the liquid actuated pump 200. That is, process fluid received at the process fluid inlet 212 can either flow through a first process fluid flow path 210a that includes the first valve 216a, a process fluid portion of the first pump chamber 230a, the second valve 218a and the process fluid outlet 214, or through a second process fluid flow path 210b that includes the third valve 216b, a process fluid portion of the second pump chamber 230b, the fourth valve 218b and the process fluid outlet 214.

In contrast to the pump unit 150 shown in FIG. 1, the pump unit 250 shown in FIG. 3 includes a first pump 258a and a second pump 258b, along with a fourth valve 262b, a fifth valve 264b, and a sixth valve 266b. Each pump 258 is part of a control liquid flow path 260 that includes the reservoir 256. Specifically, a first control liquid flow path 260a includes the reservoir 256, the first valve 262a, the first pump 258a, the second valve 264a, a control liquid portion of the first pump chamber 230a, and the third valve 266a, and returns to the reservoir 256 (or optionally to a separate waste outlet, not shown in FIG. 3 for simplicity). Likewise, a second control liquid flow path 260b includes the reservoir 256, the fourth valve 262b, the second pump 258b, the fifth valve 264b, a control liquid portion of the second pump chamber 230b, and the sixth valve 266b, and returns to the reservoir 256 (or a separate waste outlet).

Each control liquid flow path 260 is configured to accommodate a trapped volume of liquid that can be displaced by the pump 258 in that control liquid flow path 260 in order to drive movement of a process fluid in its corresponding process fluid flow path 210, in the same way as described above in relation to FIG. 1. That is, the first control liquid flow path 260a is configured to accommodate a first trapped volume of liquid by closing the first valve 262a and the third valve 266a. This first trapped volume of liquid can be displaced by the first pump 258a in order to deform a diaphragm of the first pump chamber 230a and drive movement of the process fluid in the first process fluid flow path 210a. Likewise, the second control liquid flow path 260b is configured to accommodate a second trapped volume of liquid by closing the fourth valve 262b and the sixth valve 266b. The second trapped volume of liquid can be displaced by the second pump 258b in order to deform a diaphragm of the second pump chamber 230b and drive movement of the process fluid in the second process fluid flow path 210b.

By implementing two pump chambers 230 in parallel, the first pump 258a can be used to dispense process fluid from the process fluid portion of the first pump chamber 230a while the second pump 258b is used to draw process fluid into the process fluid portion of the second pump chamber 230b. Subsequently, the second pump 258b can be used to dispense process fluid from the second pump chamber 230b while the first pump 258a is used to draw process fluid into the process fluid portion of the first pump chamber 230a. Therefore, in operation of the pumping system 290, one pump 258 is always being used for dispensing process fluid, while another pump 258 is always being used to draw process fluid into a pump chamber 230. Accordingly, by implementing two pump chambers 230 in parallel, process fluid can be continuously dispensed from one of the pump chambers 230. This means that a substantially continuous and pulsation-free flow of process fluid can be provided at the process fluid outlet 214.

As an alternative to having two pump chambers 230 in parallel that share a common process fluid inlet 212 and a common process fluid outlet 214 (i.e. as shown in FIG. 3), a liquid actuated pump may include distinct process fluid flow paths, wherein each process fluid flow path includes its own process fluid inlet, its own process fluid outlet, and a pump chamber. Such an arrangement can be used in conjunction with the pump unit 250 shown in FIG. 3 in order to pump two process fluids separately. Alternatively, the two process fluid flow paths may have different process fluid inlets but share a common process fluid outlet, such that the liquid actuated pump can be used for blending two different process fluids together.

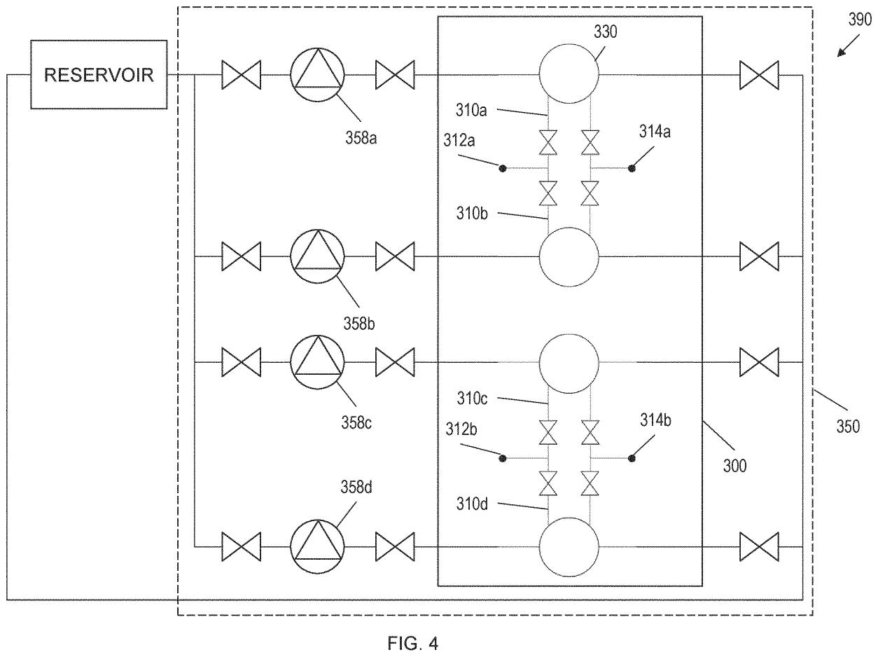

As a further alternative, shown in FIG. 4, a third pumping system 390 comprises a liquid actuated pump 300 including four pump chambers 330, and is used in conjunction with a pump unit 350 having four pumps 358. In this case, the liquid actuated pump 300 includes two sets of the parallel-connected pump chambers 230 shown in FIG. 3. As shown in FIG. 4, each set of parallel-connected pump chambers 330 has a different process fluid inlet 312. Specifically, a first process fluid inlet 312a can receive a first process fluid that can be pumped along a first process fluid flow path 310a using a first pump 358a of the pump unit 350 and pumped along a second process fluid flow path 310b using a second pump 358b of the pump unit 350. A second process fluid inlet 312b can receive a second process fluid 312b that can be pumped along a third process fluid flow path 310c using a third pump 358c of the pump unit 350 and pumped along a fourth process fluid flow path 310d using a fourth pump 358d of the pump unit 350. Therefore, the pumping system 390 uses four trapped volumes of control liquid in order to drive process fluid movement in the liquid actuated pump 300.

Each set of parallel-connected pump chambers 330 is operated in the same way as the parallel-connected pump chambers 230 shown in FIG. 3. This means that a substantially continuous and pulsation-free flow of a first process fluid can be provided at the first process fluid outlet 314a, while a substantially continuous and pulsation-free flow of a second process fluid can be provided at the second process fluid outlet 314b.

Providing continuous and pulsation-free flow of two process liquids is desirable in bioprocessing operations such as TFF. Although the process fluid outlets 314 are shown as being distinct in FIG. 4, the process fluid outlets 314 may be connected together so that the liquid actuated pump 300 can blend two different process fluids together.

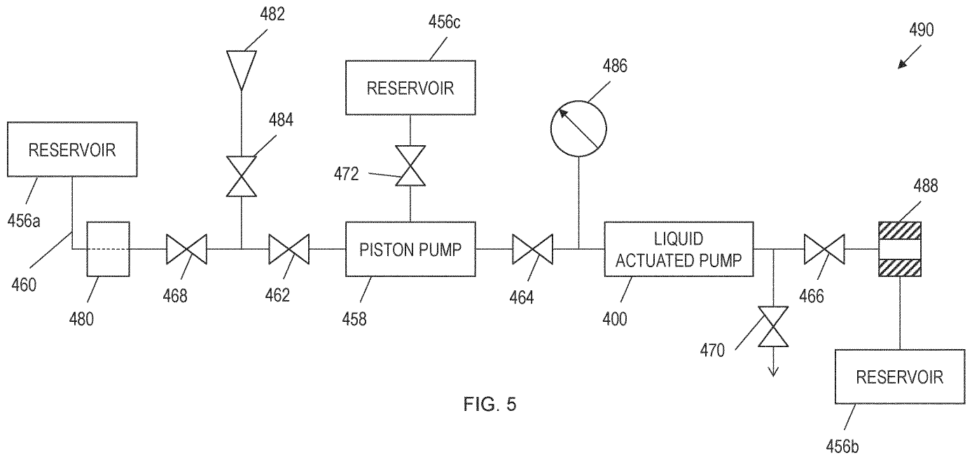

FIG. 5 is a schematic diagram of a pumping system 490 that may be representative of the pumping systems 190, 290, 390 described with reference to FIGS. 1, 3 and 4. FIG. 5 shows a control liquid flow path 460 through the pumping system 490, but does not show the process fluid flow path through the liquid actuated pump 400. Various components of the pumping system 490 may be provided in the form of a pump unit to which the liquid actuated pump 400 is connected.

The pumping system 490 includes a reservoir 456a configured to hold a control liquid such as a water-ethanol blend. A degasser 480 is disposed downstream of the reservoir 456a and is configured to remove air from the control liquid from the reservoir 456a. For example, the degasser 480 may comprise a bubble trap configured to trap any air bubbles in the flow of control liquid from the reservoir 456a. Removing air from the control liquid is preferable because any air in the trapped volume of liquid used to deform the diaphragm of the pump chamber will provide a spring effect owing to compression of the air. Such a spring effect would reduce the deformation of the diaphragm for a given displacement of the trapped volume of liquid, therefore reducing the amount of process fluid that is pumped and reducing the volume accuracy of the pumping of the process fluid.

A first valve 462 is disposed between the degasser 480 and a piston pump 458 of the pumping system 490. In one example, the first valve 462 is an active membrane valve.

The liquid actuated pump 400 is disposed downstream of the piston pump 458 in the control liquid flow path 460. Specifically, the control liquid flow path 460 includes a control liquid inlet of the liquid actuated pump 400, a control liquid portion of a pump chamber of the liquid actuated pump 400, and a control liquid outlet of the liquid actuated pump 400. Consequently, the first valve 462 is upstream of both the piston pump 458 and the liquid actuated pump 400.

A second valve 464 is disposed between the piston pump 458 and the liquid actuated pump 400 in the control liquid flow path 460. The second valve 464 is used to allow the piston pump 458 to draw control liquid from the reservoir 456a so that it can be subsequently driven through the control liquid flow path 460.

A third valve 466 is disposed downstream of both the piston pump 458 and the liquid actuated pump 400 in the control liquid flow path 460. The third valve 466 is used to trap a volume of control liquid between the first valve 462 and the third valve 466 during running of the pumping system 490.

A fourth valve 468 is disposed between the degasser 480 and the first valve 462. The fourth valve 468 can be closed to ensure that any air supplied to drain the control liquid flow path 460 is pushed through the control liquid flow path 460 in the correct direction.

The pumping system 490 also includes a gas supply (e.g. an air supply 482), which is connected to the control liquid flow path 460 in between the fourth valve 468 and the first valve 462. An air supply valve 484 is disposed between the air supply 482 and its point of connection to the control liquid flow path 460. The air supply valve 484 controls whether air is supplied to the control liquid flow path 460 to drain the control liquid flow path 460 and prevents control liquid from reaching the air supply 482. The first valve 462 isolates the piston pump 458 from any air that may be trapped in the conduit branching from the control liquid flow path 460 to the air supply 482 (which may be the case if a single valve were implemented in the location of the fourth valve 468 instead of implementing separate a first valve 462 and fourth valve 468).

In addition, the pumping system 490 includes a pressure sensor 486 configured to monitor the pressure of the volume of control liquid trapped between the first valve 462 and the third valve 466. In the example shown in FIG. 5, the pressure sensor 486 is disposed between the second valve 464 and the liquid actuated pump 400. The pressure of the trapped volume of control liquid should be substantially equal to the pressure applied to the process fluid in the liquid actuated pump (where the term “substantially” is used in recognition of minor loss in pressure owing to properties of the diaphragm). In one example, the pressure sensor 486 can be provided in the pump unit. Implementing the pressure sensor 486 in this way allows the pressure applied to the process fluid to be monitored without the need for a pressure sensor to be provided in the liquid actuated pump 400, thereby simplifying construction and operation of the liquid actuated pump 400, and minimising cost and complexity.

The pumping system 490 also includes a waste outlet valve 470 disposed between the liquid actuated pump 400 and the second valve 464. The waste outlet valve 470 permits control liquid and gas (e.g. air) to be discharged to a separate waste outlet (not shown in FIG. 5), for example during draining of the pumping system 490. The waste outlet valve 470 may be a pressure relief valve that releases control liquid above a certain pressure (e.g. 8 bar) in the event of a fault within the liquid actuated pump 400 (such as incorrect diaphragm position), and therefore prevents a build-up of pressure within the liquid actuated pump 400 from breaking the liquid actuated pump 400. In an alternative example, the second valve 464 may function as a safety valve and may be configured to release control liquid to the reservoir 456b in the event of a pressure exceeding a predetermined value (e.g. 8 bar).

The pumping system 490 also includes a bubble detector 488 disposed downstream of the second valve 464. The bubble detector 488 is used during priming of the pumping system 490 in order to verify whether there are any air bubbles in the flow of control liquid through the control liquid flow path 460. Implementing the bubble detector 488 allows for confirmation of whether priming of the pumping system 490 was successful (i.e. if there are no air bubbles in the flow of control liquid for a certain period of time). In some examples, a second bubble detector may be implemented upstream of the pump 458 in order to ensure that the reservoir 456a supplies liquid to the pump 458.

Finally, the pumping system 490 includes a rinse reservoir 456c that is connected to the piston pump 458 via a rinse reservoir valve 472. The rinse reservoir 456c supplies rinse liquid that is used to rinse ‘behind’ the piston of the piston pump 458. It will be appreciated that the piston pump 458 comprises a piston that moves within a cylinder, with a dynamic seal in between the piston and the cylinder. The region beyond the dynamic seal can potentially become contaminated and experience bioburden issues over time. Accordingly, in this context, rinsing ‘behind’ the piston means rinsing beyond the dynamic seal between the piston and cylinder, typically using a bacteriostatic fluid. In one example, the rinse reservoir 456c is the same as, or is connected to, the reservoir 456a.

Having passed through the bubble detector 488, control liquid passes to a reservoir 456b, which may be the same as the reservoir 456a at the inlet to the degasser 480 or may be a distinct reservoir 456b (which may be connected to the reservoir 456a at the inlet to the degasser 480). Implementing the reservoir 456b as a reservoir that is connected to the reservoir 456a at the inlet may be preferable particularly during priming of the pumping system 490 (described below), as the control liquid can be recirculated to reduce wastage of control liquid. Each reservoir 456a, 456b may include a vent or filter to prevent ingress of other liquids into the pumping system 490.

Typical operating pressures of the piston pump 458 during running of the pumping system 490 are between 0 bar and 4 bar. In this example, the third valve 466 is a pressure control valve that opens at pressures in excess of a predetermined maximum pressure (e.g. 6 bar), in order to prevent damage to the liquid actuated pump 400 and/or high-pressure ejection of control liquid from the pumping system 490. When the pressure supplied by the pump 458 exceeds the predetermined maximum pressure, control liquid returns to the reservoir 456b via the third valve 466.

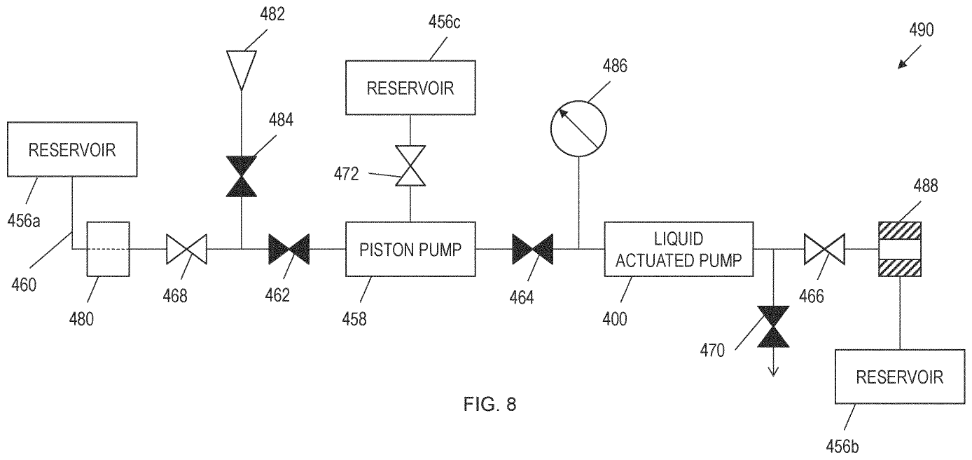

In some examples, an additional air inlet may be implemented downstream of the piston pump 458 (along with an additional valve). The additional air inlet may be used to displace control liquid in the control liquid flow path 460 to the waste outlet following operation of the pumping system 490 (e.g. as described below with reference to FIG. 8). Where an additional air inlet is present, an additional valve upstream of its connection to the control liquid flow path 460 may be incorporated, in order to prevent air from forcing control liquid to flow back towards the pump 458 and reservoir 456a. Incorporating an additional air inlet downstream of the pump 458 allows for spillage free disconnection of the liquid actuated pump 400, while retaining the piston pump 458 in a liquid filled state (meaning that the piston pump 458 does not need to be primed again). Therefore, only the portion of the control liquid flow path 460 between the pump 458 and the third valve 466 would need to be refilled with control liquid following connection of a new liquid actuated pump 400 to the pump unit 450.

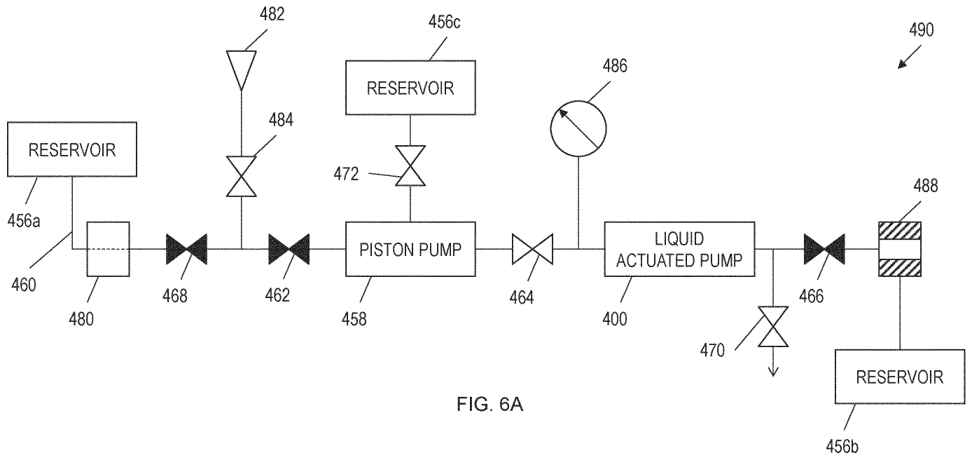

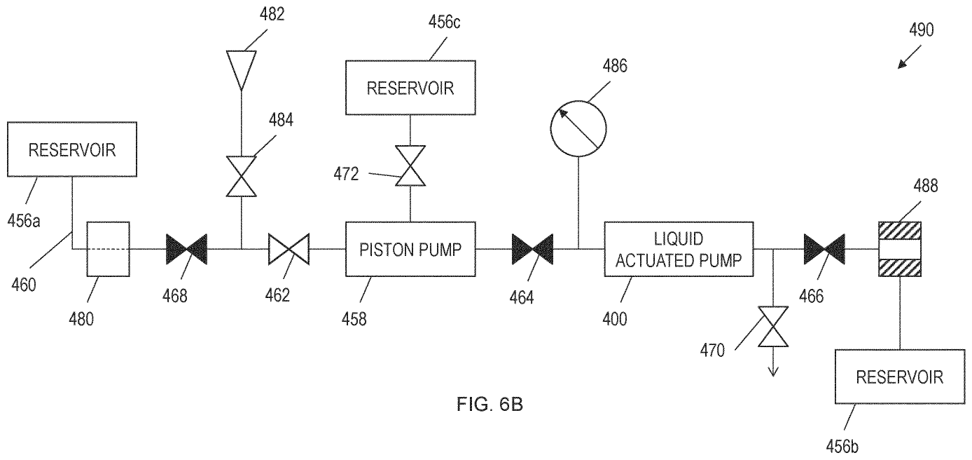

Although not shown in FIG. 5, the pumping system 490 may also include a control system, optionally comprising a PID controller or other type of feedback control, configured to control operation of the pump 458 and to actuate the valves of the pumping system 490. The control system may be configured to open certain valves and close other valves in response to the piston pump 458 being in a particular position. For example, the control system may be configured to actuate the valves from the valve states shown in FIG. 6B to the valve states shown in FIG. 6A upon determining that the piston pump 458 has reached the end of its stroke (which may, for example, be monitored using embedded software).

The control system may also be configured to receive inputs from the pressure sensor 486 and the bubble detector 488. For example, the control system may be configured to open the third valve 466 in response to an input from the pressure sensor 486 that the pressure of control liquid between the first valve 462 and the third valve 466 exceeds a threshold pressure. As another example, the control system may be configured to close the third valve 466 in response to an input from the bubble detector 488 that the flow of control liquid through the control liquid flow path 460 is free from bubbles. In particular, the control system may be configured to monitor the output from the bubble detector 488 over time and to close the third valve 466 in response to determining that the control liquid flow path 460 has been free from bubbles for a predetermined period of time. The control system may also be configured to control operation of the air supply 482, in order to drain the control liquid flow path 460 so that the liquid actuated pump 400 can be disconnected from the pump unit.

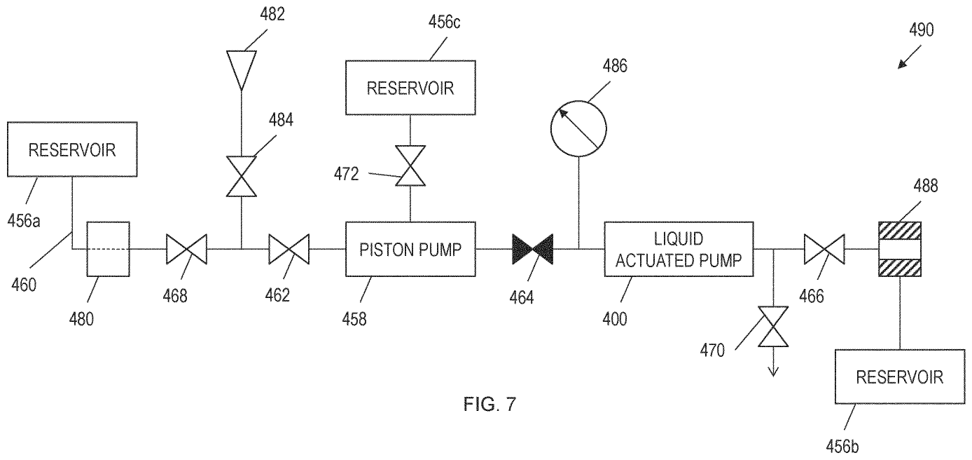

FIGS. 6A to 8 show the states of the valves of the pumping system 490 during priming of the pumping system 490 (FIGS. 6A and 6B), running of the pumping system 490 (FIG. 7), and draining of the pumping system (FIG. 8). In FIGS. 6A to 8, a valve filled in black indicates that the valve is open (i.e. permits the passage of fluid), whereas a valve filled in white indicates that the valve is closed (i.e. does not permit the passage of fluid). The rinse reservoir valve 472 is closed during priming, running and draining of the pumping system, as the rinsing of the components of the control liquid flow path is a separate process that is not illustrated in FIGS. 6A to 8.

During priming of the pumping system 490, as shown in FIGS. 6A and 6B, the first valve 462, third valve 466 and fourth valve 468 are all initially open (FIG. 6A), while the second valve 464, the air supply valve 484 and the waste outlet valve 470 are closed. This arrangement of valves allows control liquid from the reservoir 456a to be drawn through the degasser 480 and into the piston pump 458. Subsequently, the first valve 462 is closed and the second valve 464 is opened (FIG. 6B), which allows the piston pump 458 to drive the control liquid through the control liquid flow path of the liquid actuated pump 400 and the bubble detector 488, before returning to the reservoir 456b. The configurations shown in FIGS. 6A and 6B are then repeated (e.g. by the control system of the pumping system 490) until a volume of control liquid is present between the first valve 462 and the third valve 466. It will be appreciated that, during filling of the piston pump 458 (as shown in FIG. 6A), the states of the third valve 466 and the waste outlet valve 470 are inconsequential, given that the second valve 464 is closed. However, during discharge of the piston pump 458 (FIG. 6B), the third valve 466 is open and the waste outlet valve 470 is closed.

The pumping system 490 is primed in order to ensure that a volume of control liquid is present between the first valve 462 and the third valve 466 (i.e. that control liquid is in contact with the diaphragm of the liquid actuated pump 400). The degasser 480 and bubble detector 488 are used to verify that the control liquid passing through the third valve 466 is free of air bubbles, so as to minimise or eliminate the risk of the trapped volume of control liquid containing air bubbles once the first valve 462 and the third valve 466 are closed.

In order to calibrate the position of the pump 458 with the position of the diaphragm of the liquid actuated pump 400, a volume of control liquid is first trapped between the first valve 462 and the third valve 466 by closing the first valve 462 and the third valve 466 (e.g. by the control system). The pump 458 is then used to supply a positive pressure to the trapped volume of liquid, which deforms the diaphragm of the liquid actuated pump 400. Once the diaphragm reaches the bottom of the pump chamber of the liquid actuated pump 400 (i.e. once the volume of the process fluid portion of the pump chamber is zero), the pressure at the inlet to the third valve 466 will increase. As the third valve 466 is a pressure control valve, any excess pressure from the pump causes control liquid to flow through the third valve 466, until the pump 458 reaches the end of its stroke. At that point, the pump 458 is at the end of its stroke, and the diaphragm is at its maximum positive displacement position, meaning that the pump 458 and diaphragm are calibrated.

The leakage of excess control liquid through the third valve 466 may be achieved by setting the pressure control valve to permit the flow of control liquid when the pressure of the control liquid between the pump 458 and the third valve 466 exceeds around 0.2 to 0.3 bar. The position of the piston of the pump 458 can be monitored using embedded software that reads the piston position, which allows the end position of the piston (i.e. the end of the stroke of the pump 458) to be determined by the control system.

The remaining volume of trapped control liquid (i.e. the initial volume trapped between the first valve 462 and the third valve 466, minus any control liquid that flowed through the third valve 466 as a result of the excess pressure from the pump 458) can then be used during operation in order to drive movement of the process fluid. Prior to operation of the pumping system 190 (i.e. once calibration is complete), the threshold pressure of the third valve 466 may be increased (e.g. by the control system) to a higher pressure (e.g. at least 6 bar), so that the volume of control liquid between the first valve 462 and the third valve 466 is securely trapped. Consequently, calibration of the liquid actuated pump 400 and the pump unit can be achieved without the use of sensors to detect the position of the diaphragm. During the priming and calibration process, the pressure of the control liquid trapped between the first valve 462 and the second valve 466 can be monitored using the pressure sensor 486.

Alternatively, the third valve 466 may be operated as a ‘pulsating’ valve, which is periodically opened for short periods (e.g. less than 0.05 seconds) in order to release excess pressure so that the pressure of the trapped volume of control liquid can be kept within a set pressure range (e.g. between 0.2 bar and 0.5 bar). In this case, the third valve 466 can be implemented as an on-off valve rather than a pressure control valve. The pressure of the control liquid trapped between the first valve 462 and the third valve 466 can be monitored (e.g. using the pressure sensor 486), which may provide an input to the control system, which controls actuation of the third valve 466 (e.g. to open the third valve 466 when the pressure monitored by the pressure sensor 486 exceeds 0.5 bar).

During running of the pumping system 490, as shown in FIG. 7, all valves are closed except for the second valve 464. This means that a volume of control liquid is trapped between the first valve 462 and the third valve 466. The piston pump 458 can be used to pressurise the trapped volume of control liquid, which in turn applies the pressure supplied by the piston pump 458 to the diaphragm of the pump chamber of the liquid actuated pump 400. This causes deformation of the liquid actuated pump 400, which drives movement of a process fluid in the process fluid flow path of the liquid actuated pump 400.

During draining of the pumping system 490, as shown in FIG. 8, the air supply valve 484 is opened (e.g. by the control system), along with the first valve 462, the second valve 464 and the waste outlet valve 470. The other valves (i.e. the third valve 466 and the fourth valve 468) are closed. Opening the air supply valve 484 causes air to be supplied to the control liquid flow path 460 from the air supply 482, allowing fluid within the control liquid flow path 460 to be forced out to the waste outlet via the waste outlet valve 470. Closing the fourth valve 468 prevents air being supplied in the reverse direction (i.e. to the reservoir 456a via the degasser 480). Draining the control liquid from the control liquid flow path 460 allows the liquid actuated pump 400 to be disconnected from the pump unit without spillage of control liquid, thereby improving ease of disconnection of the liquid actuated pump 400 from the pump unit (e.g. for disposal or cleaning of the liquid actuated pump 400). In addition, draining the control liquid to the waste outlet is preferable because the drained control liquid is mixed with air. Accordingly, draining the control liquid to the waste outlet avoids routing air bubbles to the control liquid reservoir.

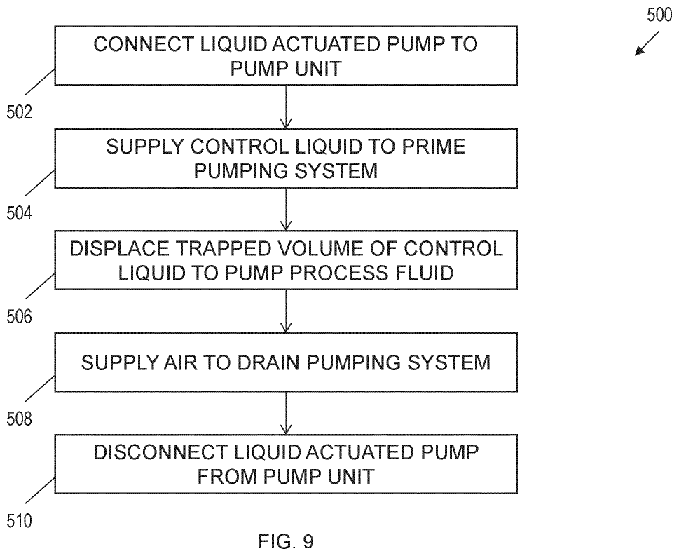

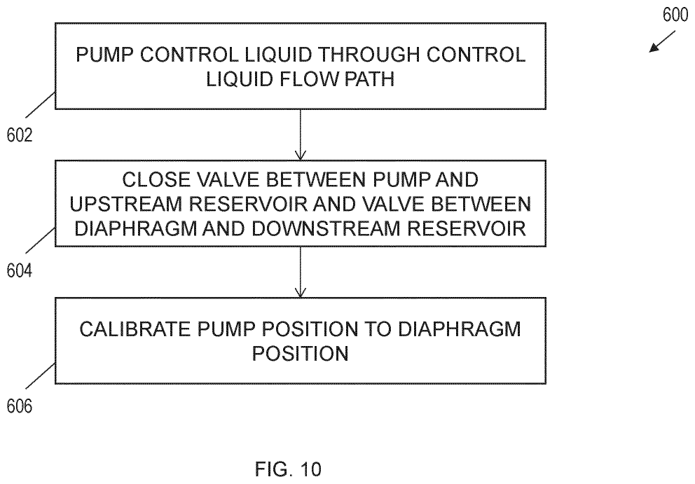

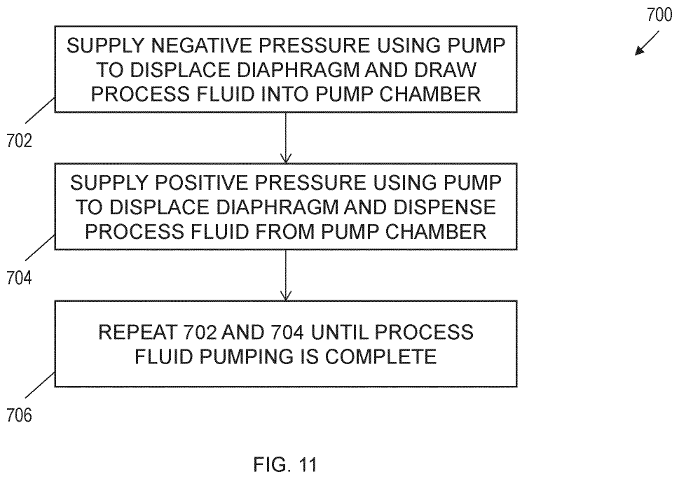

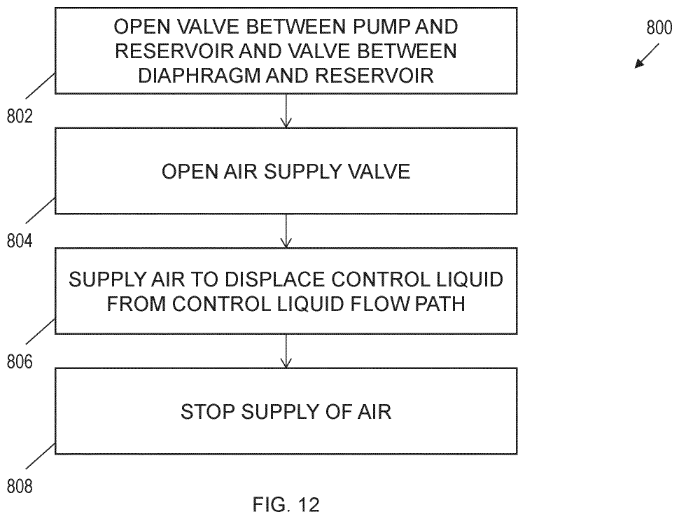

FIG. 9 is a flowchart of a method 500 of performing a pumping operation to pump a process fluid using a pumping system comprising a liquid actuated pump and a pump unit. The method 500 may be implemented using the pumping systems 190, 290, 390, 490 described above. In particular, the method 500 may be implemented using a control system of a pumping system (e.g. as described above with reference to FIG. 5). In this way, operation of the pumping system (described with reference to FIG. 11) can be performed automatically under the control of the control system. In addition, priming and calibration of the pumping system (described with reference to FIG. 10) can be performed automatically under the control of the control system, which may receive inputs from embedded pump software, one or more pressure sensors, and/or one or more bubble detectors. Further, draining of the pumping system (described with reference to FIG. 12) can also be performed automatically under the control of the control system.

At 502, the liquid actuated pump is connected to the pump unit.

At 504, control liquid is supplied by the pump unit in order to prime the pumping system. Priming the pumping system comprises trapping a volume of control liquid in a portion of a control liquid flow path, the portion of the control liquid flow path comprising a pump of the pump unit and a control liquid portion of a pump chamber of the liquid actuated pump, where the control liquid portion is defined in part by a flexible diaphragm of the pump chamber. The priming of the pumping system is described in more detail below with reference to FIG. 10.

Once the pumping system is primed, the trapped volume of control liquid in the control liquid flow path is displaced at 506 in order to pump the process fluid (e.g. a process liquid). Specifically, the displacement of the trapped volume of control liquid causes displacement of the flexible diaphragm of the pump chamber of the liquid actuated pump, which changes the volume of a process fluid portion of the pump chamber that is also defined in part by the flexible diaphragm. The change in volume of the process fluid portion drives movement of the process fluid in a process fluid flow path of the liquid actuated pump, where the process fluid flow path includes the process fluid portion. Operation of the pumping system to pump the process fluid is described in more detail below with reference to FIG. 11.

Once the process fluid has been pumped as required by the bioprocessing operation being carried out using the pumping system, gas (e.g. air) is supplied at 508 in order to drain the pumping system. Specifically, air is supplied to displace the trapped volume of control liquid from the control liquid flow path. Draining of the pumping system is described in more detail below with reference to FIG. 12.

Once the pumping system has been drained, the liquid actuated pump can be disconnected from the pump unit at 510. Given that the pumping system has been drained, the risk of leakage or spillage of control liquid during disconnection of the liquid actuated pump is minimised.

Following disconnection of the liquid actuated pump, the components of the pump unit may be cleaned by rinsing with the control liquid. Another liquid actuated pump may then be connected to the pump unit in order to pump process fluid required for another bioprocessing operation.

FIG. 10 is a flowchart of a method 600 of priming a pumping system. The method 600 may be implemented using any of the pumping systems 190, 290, 390, 490 described above, and may be implemented in order to carry out step 504 of method 500.

At 602, control liquid is pumped through the control liquid flow path. The control liquid is pumped from an upstream reservoir of control liquid using the pump of the pump unit. Pumping the control liquid may initially comprise opening one or more valves between the upstream reservoir and the pump, closing a valve between the pump of the pump unit and the liquid actuated pump, and applying a negative pressure using the pump of the pump unit, to draw control liquid from the upstream reservoir into the pump. Pumping the control liquid may subsequently comprise closing one or more valves between the upstream reservoir and the pump, opening the valve between the pump of the pump unit and the liquid actuated pump, and applying a positive pressure using the pump of the pump unit while a valve between the diaphragm of the liquid actuated pump and a downstream reservoir is open. The downstream reservoir may be the same as or connected to the upstream reservoir in examples in which the control liquid flow path is a circuit.

In one example, pumping the control liquid comprises pumping the control liquid through a degasser disposed upstream of a valve between the upstream reservoir and the pump. In addition, pumping the control liquid may comprise pumping the control liquid through a bubble detector disposed downstream of the valve between the diaphragm of the liquid actuated pump and the downstream reservoir.

Once the portion of the control liquid flow path between the pump and the diaphragm of the pump chamber is filled with control liquid, then at 604, the valve between the upstream reservoir and the pump is closed, in addition to closing the valve between the diaphragm and the downstream reservoir. Closing these valves traps a volume of control liquid between the valves.

In one example, the valve between the upstream reservoir and the pump and the valve between the diaphragm and the downstream reservoir are closed once the bubble detector detects that the control liquid flowing through the control liquid flow path is free from bubbles.

Once the valve between the upstream reservoir and the pump and the valve between the diaphragm and the downstream reservoir are closed, then the pump position is calibrated to the diaphragm position at 606. Calibrating the pump position to the diaphragm position may comprise supplying positive pressure from the pump to deform the diaphragm to its maximum positive displacement position. At this point, the diaphragm cannot be displaced any further, and the volume of the process fluid portion of the pump chamber is zero.

Once the diaphragm is at its maximum displacement, the supply of positive pressure from the pump is continued until the pump reaches its maximum positive displacement position (e.g. the end of its stroke, for a piston pump). During this continued supply of positive pressure, excess pressure from the pump causes control liquid to flow through the valve between the diaphragm and the downstream reservoir, because this valve is a pressure control valve. Once the pump reaches its maximum displacement position, then the maximum positive displacement position of the pump is calibrated to the maximum positive displacement position of the diaphragm.

FIG. 11 is a flowchart of a method 700 of operating the pumping system to pump the process fluid. The method 700 may be implemented using any of the pumping systems 190, 290, 390, 490 described above, and may be implemented in order to carry out step 506 of method 500.

At 702, negative pressure is supplied using the pump in order to displace the diaphragm of the liquid actuated pump and draw process fluid into the pump chamber. Negative pressure may be initially supplied in the method 700 because the diaphragm may be at its maximum positive displacement position following calibration of the pump position to the diaphragm position at 606. The negative pressure supplied using the pump at 702 displaces the diaphragm of the liquid actuated pump such that the volume of the process fluid portion of the pump chamber increases (e.g. from the zero volume of the process fluid portion during calibration at 606). The increase in volume of the process fluid portion draws process fluid into the process fluid portion through the process fluid flow path.

Where the liquid actuated pump includes active valves, supplying negative pressure at 702 may comprise opening a first valve disposed upstream of the pump chamber in the process fluid flow path, and closing a second valve disposed downstream of the pump chamber in the process fluid flow path.

At 704, positive pressure is supplied using the pump in order to displace the diaphragm of the liquid actuated pump and dispense process fluid from the pump chamber. The positive pressure supplied by the pump at 704 displaces the diaphragm of the liquid actuated pump such that the volume of the process fluid portion of the pump chamber reduces (i.e. as a result of a corresponding increase in volume of the control liquid portion of the pump chamber). The reduction in volume of the process fluid portion forces process fluid out of the process fluid portion through the process fluid flow path.

Where the liquid actuated pump includes active valves, supplying positive pressure at 704 may comprise closing the first valve disposed upstream of the pump chamber in the process fluid flow path, and opening the second valve disposed downstream of the pump chamber in the process fluid flow path.

Optionally, the pump unit may be used to supply pressure to two pump chambers of the liquid actuated pump. Accordingly, the pump used to supply positive pressure at 704 may be a first pump, and the positive pressure supplied at 704 may displace a diaphragm of a first pump chamber of the liquid actuated pump. In this case, during the supply of positive pressure by the first pump at 704, negative pressure may be supplied using a second pump in order to displace a diaphragm of a second pump chamber of the liquid actuated pump and draw process fluid into the second pump chamber (i.e. in the same manner as described above in relation to 702).

At 706, steps 702 and 704 are repeated until a required volume of the process fluid has been pumped (i.e. until the pumping operation is complete). Where the pump unit is used to supply pressure to two pump chambers of the liquid actuated pump, then during the repeated supply of negative pressure using the first pump (as described with reference to 702) at 706, positive pressure may be supplied using the second pump in order to displace the diaphragm of the second pump chamber and dispense process fluid from the second pump chamber. By operating the pumping system in this way, one pump of the pump unit is always used at 706 to dispense process fluid from a pump chamber, meaning that the pumping system can be used to drive a continuous and pulsation free supply of process fluid.

FIG. 12 is a flowchart of a method 800 of draining a pumping system. The method 800 may be implemented using any of the pumping systems 190, 290, 390, 490 described above, and may be implemented in order to carry out step 508 of method 500.

Once the required volume of process fluid has been pumped using the pumping system, then at 802, the valve between the upstream reservoir and the pump may be opened, in addition to opening a valve between the diaphragm and a waste outlet. To prevent control liquid from being drained to the downstream reservoir, the valve between the diaphragm and the downstream reservoir may be kept closed. By opening these valves, a volume of control liquid is no longer trapped between the pump and the diaphragm.

At 804, an air supply valve is opened. Opening the air supply valve brings the control liquid flow path into fluidic communication with an air supply. The air supply valve may connect the air supply to the control liquid flow path at a point upstream of the valve between the upstream reservoir and the pump, but downstream of the degasser (if present). An additional valve between the degasser and the connection point of the air supply to the control liquid flow path may be closed to prevent air from being supplied to the upstream reservoir via the degasser.

Once the air supply valve is opened, then air is supplied at 806 in order to displace control liquid from the control liquid flow path. The air supplied at 806 may force the control liquid through the control liquid flow path to a waste outlet. Draining the pumping system to a waste outlet (rather than the control liquid reservoir) is preferable because the drained control liquid will be mixed with air supplied by the air supply.

Once the control liquid flow path has been cleared of control liquid, the supply of air is stopped at 808. Stopping the supply of air may comprise closing the air supply valve. At this point, the liquid actuated pump can be disconnected from the pump unit without spillage of control liquid.

The control system of the pumping system may also be used to carry out other methods involving the pumping system. For example, the control system may be configured to control the pumping system in order to replace control fluid, or to calibrate the pumping system to correct drift or degassing issues.

Variations or modifications to the systems and methods described herein are set out in the following paragraphs.

Although the pumping systems mentioned above are described with particular reference to a piston pump, other types of pump may be used to drive movement of the trapped volume of liquid.

Although FIGS. 1, 3 and 4 show control liquid being returned to the reservoir from which it is initially supplied (e.g. during priming of the pumping system), the control liquid received via the pump unit inlet 152 may, in alternative examples, be routed to a separate waste chamber during priming of the pumping system. In other words, the control liquid flow path 160 is not necessarily a circuit. Likewise, although FIGS. 1 and 4 show that control liquid can be drained to a waste outlet, alternative examples may not include a waste outlet and control liquid may simply be drained to the control liquid reservoir.

In one example, multiple reservoirs may be implemented, so that a selection of different liquids can be made at an inlet to the control liquid flow path 160. For example, after disconnection of the liquid actuated pump 400, a cleaning procedure may be initiated by connecting the pump 158 to a reservoir of cleaning fluid, in order to clean the portion of the control liquid flow path 160 within the pump unit 150. Once the components of the pump unit 150 have been cleaned, the pump 158 may be reconnected to the reservoir 156 of control liquid, so that the control liquid flow path 160 can be refilled with control liquid for a subsequent pumping operation.

In the example shown in FIG. 1, the first valve 162 is disposed between the reservoir 156 and the pump 158, and the third valve 166 is disposed between the pump unit inlet 152 and the reservoir 156. It will be appreciated, however, that in an alternative arrangement, the pump 158 may be disposed between the reservoir 156 and the pump unit inlet 152, the first valve 162 may be disposed between the reservoir 156 and the pump unit outlet 154, and the third valve 166 may be disposed between the reservoir 156 and the pump 158.

In both of these examples, therefore, the first valve 162 is upstream of both the liquid actuated pump 100 and the pump 158, the second valve 164 is between the liquid actuated pump 100 and the pump 158, and the third valve 166 is downstream of both the liquid actuated pump 100 and the pump 158. Accordingly, one of the valves 162, 166 is disposed between the reservoir 156 and the pump 158. However, it is not necessary for the other one of the valves 162, 166 to be a component of the pump unit 150. In addition, it is not necessary for the second valve 164 to be a component of the pump unit 150. For example, the other one of the valves 162, 166 could be a component of the liquid actuated pump 100, and the second valve 164 could be a component of the liquid actuated pump 100. The pump unit 150 may, therefore, include only one of the valves 162, 166, which may be closed to cause a volume of control liquid to be trapped in a portion of the control liquid flow path 160 (i.e. in conjunction with the closure of the other one of the valves 162, 166 implemented, for example, in the liquid actuated pump 100). Incorporating both valves 162, 166 and the second valve 164 into the pump unit 150 is advantageous, however, for minimising the number of parts of the liquid actuated pump 100, and consequently the cost, complexity and material usage of the liquid actuated pump 100.

Although not shown in the figures, the connections between the liquid actuated pump 100 and the pump unit 150 may include valves that prevent the spillage of control liquid during connection and disconnection of the liquid actuated pump 100 (thereby ensuring dry connection and removal). Such valves may be opened when the liquid actuated pump 100 is connected to the pump unit 150 and closed when the liquid actuated pump 100 is removed from the pump unit 150. Such valves may be implemented in the liquid actuated pump 100, the pump unit 150, and/or tubing connecting the liquid actuated pump 100 and the pump unit 150. The valves may be active valves that are actuated under the control of a user prior to connection and/or disconnection of the liquid actuated pump 100 and the pump unit 150. Alternatively, the valves may be actuated by the action of connecting and/or disconnecting the liquid actuated pump 100 and the pump unit 150 (such as one or more duckbill valves that are opened by the insertion of a connector).

The term “pump unit” as used herein is not intended to necessitate that all components of the pump unit are integrated into a single device. Instead, the components of the pump unit may be provided as modular components that are connected together into a connected system of components. For example, a first modular component may include one or more piston pumps, a second modular component may include a reservoir, and a third modular component may include a valve manifold. Each of these components may be connected together in order to provide the functionality of the pump unit described in the above implementations.

In addition, although the liquid actuated pump and the pump unit have been described above as separate components, it will be appreciated that the same functionality may be provided by integrating the liquid actuated pump and the pump unit into a single component. Accordingly, a liquid actuated pump and pump unit may be provided in the form of an integrated component as an alternative to connecting the liquid actuated pump to the pump unit. Providing a connectable liquid actuated pump is preferable, however, as it allows a low cost, typically single-use pumping component to be used to pump a process fluid by connecting the low-cost pumping component to a pump unit that is typically of higher cost. In addition, such an arrangement allows the pump unit to be used with multiple single-use liquid actuated pumps.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid actuated pump (100, 200, 300, 400) for a bioprocessing system, the pump (100, 200, 300, 400) comprising:
a pump chamber (130, 230, 330);
a flexible diaphragm (132) configured to form a barrier between a control liquid portion (136) of the pump chamber (130, 230, 330) and a process fluid portion (134) of the pump chamber (130, 230, 330);
a process fluid flow path (110, 210, 310) comprising the process fluid portion (134) of the pump chamber (130, 230, 330); and
a control liquid flow path (120, 220) comprising:
an inlet (122) to the pump (100, 200, 300, 400);
an outlet (124) from the pump (100, 200, 300, 400); and
the control liquid portion (136) of the pump chamber (130, 230, 330);
wherein the control liquid flow path (120, 220) is configured to accommodate at least part of a trapped volume of control liquid, and wherein displacement of the trapped volume of control liquid causes deformation of the flexible diaphragm (132), the deformation of the flexible diaphragm (132) causing movement of a process fluid in the process fluid flow path (110, 210, 310).

2. The liquid actuated pump (100, 200, 300, 400) according to claim 1, wherein the pump (100, 200, 300, 400) is configured for connection to a pump unit (150, 250, 350) configured to displace the trapped volume of control liquid, wherein at least part of the trapped volume of control liquid is optionally accommodated in the pump unit (150, 250, 350).

3. The liquid actuated pump (100, 200, 300, 400) according to claim 2, wherein:
the inlet (122) is configured to receive the control liquid from a pump unit outlet (154) of the pump unit (150, 250, 350); and
the outlet (124) is configured to provide the control liquid to a pump unit inlet (152) of the pump unit (150, 250, 350).

4. The liquid actuated pump (100, 200, 300, 400) according to any of claims 1 to 3, wherein the process fluid flow path (110, 210) further comprises:
a first valve (116, 216) disposed between a process fluid inlet (112, 212, 312) and the process fluid portion (134) of the pump chamber (130, 230, 330); and
a second valve (118, 218) disposed between the process fluid portion (134) of the pump chamber (130, 230, 330) and a process fluid outlet (114, 214, 314).

5. The liquid actuated pump (100, 200, 300, 400) according to claim 4, wherein:
each of the first valve (116, 216) and the second valve (118, 218) is a check valve; or
each of the first valve (116, 216) and the second valve (118, 218) is a fluid-actuated membrane valve.

6. The liquid actuated pump (200, 300, 400) according to any of claims 1 to 5, further comprising:
a second pump chamber (230b) connected in parallel with the pump chamber (230a);
a second flexible diaphragm configured to form a barrier between a control liquid portion of the second pump chamber (230b) and a process fluid portion of the second pump chamber (230b);
a second process fluid flow path (210b, 310b, 310c, 310d) comprising the process fluid portion of the second pump chamber (230b);
a second control liquid flow path (220b) comprising:
a second inlet to the pump (200, 300, 400);
a second outlet from the pump (200, 300, 400); and
the control liquid portion of the second pump chamber (230b);
wherein the second control liquid flow path (220b) is configured to accommodate at least part of a second trapped volume of control liquid, and wherein displacement of the second trapped volume of control liquid causes deformation of the second flexible diaphragm, the deformation of the second flexible diaphragm causing movement of a process fluid in the second process fluid flow path (210b, 310b, 310c, 310d).

7. The liquid actuated pump (200, 300, 400) according to claim 6, further comprising a process fluid inlet (212, 312), and wherein each of the process fluid flow path (210a, 310a) and the second process fluid flow path (210b, 310b) is configured to receive the process fluid via the process fluid inlet (212, 312).

8. The liquid actuated pump (300, 400) according to claim 6, further comprising a first process fluid inlet (312a) and a second process fluid inlet (312b), wherein the process fluid flow path (310a) is configured to receive a first process fluid via the first process fluid inlet (312a), and wherein the second process fluid flow path (310c, 310d) is configured to receive a second process fluid via the second process fluid inlet (312b), wherein the second process fluid is different to the first process fluid.

9. A pump unit (150, 250, 350) for a bioprocessing system, the pump unit comprising:
a pump unit outlet (154) configured for connection to a control liquid inlet (122) of a liquid actuated pump (100, 200, 300, 400);
a pump unit inlet (152) configured for connection to a control liquid outlet (124) of the liquid actuated pump (100, 200, 300, 400), such that a control liquid flow path (160, 260, 460) includes the pump unit outlet (154), the liquid actuated pump (100, 200, 300, 400), and the pump unit inlet (152);
a pump (158, 258, 358, 458) configured to drive movement of a control liquid in the control liquid flow path (160, 260, 460); and
one or more valves (162, 262, 462, 166, 266, 466) configured to cause a volume of control liquid to be trapped in a portion of the control liquid flow path (160, 260, 460) comprising the pump (158, 258, 358, 458) and the liquid actuated pump (100, 200, 300, 400), such that movement of the pump (158, 258, 358, 458) causes displacement of the trapped volume of control liquid.

10. The pump unit (150, 250, 350) according to claim 9, wherein the pump unit (150, 250, 350) is configured for connection to a reservoir (156, 256, 456) configured to store the control liquid, wherein the pump (158, 258, 358, 458) is configured to drive movement of the control liquid from the reservoir (156, 256, 456) to the control liquid flow path (160, 260, 460).

11. The pump unit (150, 250, 350) according to claim 9 or claim 10, wherein the control liquid comprises a blend of water and an alcohol, optionally wherein the alcohol is ethanol.

12. The pump unit (150, 250, 350) according to any of claims 9 to 11, further comprising a pressure sensor (486) configured to detect a pressure of the volume of control liquid trapped in the portion of the control liquid flow path (160, 260, 460).

13. The pump unit (150, 250, 350) according to any of claims 9 to 12, further comprising a degasser (480) disposed upstream of the pump (150, 250, 350) in the control liquid flow path (160, 260, 460).

14. The pump unit (150, 250, 350) according to any of claims 9 to 13, further comprising a bubble detector (488) configured to detect whether gas bubbles are present in control liquid flowing through the control liquid flow path (160, 260, 460).

15. The pump unit (150, 250, 350) according to any of claims 9 to 14, wherein the one or more valves (162, 262, 462, 166, 266, 466) comprise:
a first valve (162, 262, 462) disposed upstream of the pump (158, 258, 358, 458) and the liquid actuated pump (100, 200, 300, 400) in the control liquid flow path (160, 260, 460);
a second valve (164, 264, 464) disposed between the pump (158, 258, 358, 458) and the liquid actuated pump (100, 200, 300, 400) in the control liquid flow path (160, 260, 460); and
a third valve (166, 266, 466) disposed downstream of the pump (158, 258, 358, 458) and the liquid actuated pump (100, 200, 300, 400) in the control liquid flow path (160, 260, 460).

16. The pump unit (150, 250, 350) according to claim 15, wherein the third valve (166, 266, 466) is a pressure control valve configured to permit the flow of control liquid when the pressure of control liquid trapped in the portion of the control liquid flow path (160, 260, 460) exceeds a predetermined pressure.

17. The pump unit (150, 250, 350) according to any of claims 9 to 16, wherein the pump (158, 258, 358, 458) is a displacement pump.

18. A method of pumping a process fluid in a bioprocessing system, the method comprising:
providing a liquid actuated pump (100, 200, 300, 400) and a pump unit (150, 250, 350), wherein the liquid actuated pump (100, 200, 300, 400) comprises:
a pump chamber (130, 230, 330); and
a flexible diaphragm (132) configured to form a barrier between a control liquid portion (136) of the pump chamber (130, 230, 330) and a process fluid portion (134) of the pump chamber (130, 230, 330);
trapping a volume of control liquid in a portion of a control liquid flow path (160, 260, 460), wherein the portion of the control liquid flow path (160, 260, 460) comprises a pump (158, 258, 358, 458) of the pump unit (150, 250, 350) and the control liquid portion (136) of the pump chamber (130, 230, 330); and
displacing the trapped volume of control liquid using the pump (158, 258, 358,

458) to deform the flexible diaphragm (132) and cause movement of a process fluid in a process fluid flow path (110, 210, 310) comprising the process fluid portion (134) of the pump chamber (130, 230, 330).

19. The method according to claim 18, wherein providing the liquid actuated pump (100, 200, 300, 400) and the pump unit (150, 250, 350) comprises connecting the liquid actuated pump (100, 200, 300, 400) to the pump unit (150, 250, 350).

20. The method according to claim 18 or claim 19, wherein the portion of the control liquid flow path (160, 260, 460) is between:
a valve (162, 262, 462) upstream of the pump (158, 258, 358, 458) of the pump unit (150) and the liquid actuated pump (100, 200, 300, 400) in the control liquid flow path (160, 260, 460); and
a valve (166, 266, 466) downstream of the pump (148, 258, 358, 458) of the pump unit (150) and the liquid actuated pump (100, 200, 300, 400) in the control liquid flow path (160, 260, 460);
wherein trapping the volume of control liquid in the portion of the control liquid flow path (160, 260, 460) comprises:
pumping, using the pump (158, 258, 358, 458), control liquid through the control liquid flow path (160, 260, 460) until the portion of the control liquid flow path (160, 260, 460) is filled with control liquid; and
closing the valve (162, 262, 462) upstream of the pump (158, 258, 358, 458) of the pump unit (150) and the liquid actuated pump (100, 200, 300, 400) in the control liquid flow path (160, 260, 460); and
closing the valve (164, 264, 464) downstream of the pump (148, 258, 358, 458) of the pump unit (150) and the liquid actuated pump (100, 200, 300, 400) in the control liquid flow path (160, 260, 460).

21. The method according to any of claims 18 to 20, wherein trapping the volume of control liquid in the portion of the control liquid flow path (160, 260, 460) comprises pumping, using the pump (158, 258, 358, 458) control liquid through a degasser (480) disposed upstream of the pump (158, 258, 358, 458) in the control liquid flow path (160, 260, 460).

22. The method according to any of claims 18 to 21, wherein trapping the volume of control liquid in the portion of the control liquid flow path (160, 260, 460) comprises:
detecting, using a bubble detector (488), whether gas bubbles are present in control liquid flowing through the portion of the control liquid flow path (160, 260, 460); and
trapping the volume of control liquid in response to detecting that control liquid flowing through the portion of the control liquid flow path (160, 260, 460) does not include gas bubbles.

23. The method according to any of claims 18 to 22, further comprising calibrating a maximum displacement position of the pump (158, 258, 358, 458) to a maximum displacement position of the flexible diaphragm (132), said calibration comprising:
supplying a positive pressure using the pump (158, 258, 358, 458) to displace the trapped volume of liquid until the flexible diaphragm (132) is deformed to its maximum displacement position; and
continuing to supply positive pressure using the pump (158, 258, 358, 458) until the pump (158, 258, 358, 458) reaches its maximum displacement position.

24. The method according to any of claims 18 to 23, further comprising supplying gas to displace the trapped volume of control liquid from the portion of the control liquid flow path (160, 260, 460).

25. The method according to any of claims 18 to 24, further comprising detecting a pressure of the trapped volume of control liquid using a pressure sensor (486).

26. The method according to any of claims 18 to 25, wherein the liquid actuated pump (200, 300, 400) comprises:
a second pump chamber (230b) connected in parallel with the pump chamber (230a); and
a second flexible diaphragm (132) configured to form a barrier between a control liquid portion (136) of the second pump chamber (230b) and a process fluid portion (134) of the second pump chamber (230b);
wherein the method further comprises:
trapping a second volume of control liquid in a portion of a second control liquid flow path (260b), wherein the portion of the second control liquid flow path (260b) comprises a second pump (258b, 358b) of the pump unit (250, 350) and the control liquid portion (136) of the second pump chamber (230b);
supplying a positive pressure using the pump (258a, 358a) to displace the trapped volume of control liquid, wherein displacement of the trapped volume of control liquid deforms the flexible diaphragm (132) to dispense process fluid from the process fluid portion (134) of the pump chamber (230a); and
during the supply of positive pressure using the pump (258a, 358a), supplying a negative pressure using the second pump (258b, 358b) to displace the second trapped volume of control liquid, wherein displacement of the second trapped volume of control liquid deforms the second flexible diaphragm (132) to draw process fluid into the process fluid portion (134) of the second pump chamber (230b).

27. The method according to claim 26, further comprising:
supplying a negative pressure using the pump (258a, 358a) to displace the trapped volume of control liquid, wherein displacement of the trapped volume of control liquid deforms the flexible diaphragm (132) to draw process fluid into the process fluid portion (134) of the pump chamber (230a); and
during the supply of negative pressure using the pump (258a, 358a), supplying a positive pressure using the second pump (258b, 358b) to displace the second trapped volume of control liquid, wherein displacement of the second trapped volume of control liquid deforms the second flexible diaphragm (132) to dispense process fluid from the process fluid portion (134) of the second pump chamber (230b).

28. A thermoplastic elastomer (TPE) for use as a flexible diaphragm (132), said TPE comprising:
at least one elastomeric material; and
at least one thermoplastic material having a glass transition temperature (Tg) from about 65 to about 95° C.

29. The TPE of claim 28, wherein the at least one elastomeric material comprises a SEBS (Styrene-Ethylene-Butadiene-Styrene) matrix.

30. The TPE of claim 29, wherein the at least one elastomeric material further comprises soft and stiff segments therein.

31. The TPE of claim 30, wherein the soft segments comprise polyethylene and/or polybutadiene and/or the stiff segments comprise polystyrene.

32. The TPE of any of claims 28 to 31, wherein at least one thermoplastic material has a glass transition temperature (Tg) from about 70° C. to about 85° C., such as from about 75° C. to about 80° C.
